(19) United States
(12) Patent Application Publication
(10) Pub. No.: US 2001/0044845 A1
(43) Pub. Date: Nov. 22, 2001

(54) METHOD AND APPARATUS TO CHANGE CLASS OF SERVICE LEVELS

(76) Inventors: THOMAS J. CLOONAN, LISLE, IL (US); STEVEN J. KRAPP, ARLINGTON HEIGHTS, IL (US); JEFF R. SHRODA, BOLINGBROOK, IL (US); ALAN DOUCETTE, NAPERVILLE, IL (US); WILLIAM P. WARD, OAK LAWN, IL (US)

Correspondence Address: GEORGE H. GATES, GATES & COOPER LLP, 6701 CENTER DRIVE WEST, SUITE 1050, HOWARD HUGES CENTER, LOS ANGLES, CA, 90045, US

(21) Appl. No.: 09/476,539

(22) Filed: Jan. 3, 2000

(51) Int. Cl. G06F 15/16; G06F 15/173

(52) U.S. Cl. 709/226; 709/250; 709/203

(57) ABSTRACT

Cable data service levels can be upgraded or downgrade automatically, on a subscriber's request, by using the unique identifier preprogrammed into industry-standard-compliant cable modems. A processor adjunct to the CMTS in a cable data system receives and processes service level change requests. Requests that are granted are sent back to the CMTS for subsequent execution. Faster internet access can be provided on a customer's own initiation.

### FIELD OF THE INVENTION

This invention relates to cable data systems. In particular, this invention relates to a method and apparatus for providing user-changeable (i.e., changeable by the subscriber) service level changes in a cable data system.

### BACKGROUND OF THE INVENTION

Cable communication systems are well known. These systems are now widely used to distribute television and other video programming to households throughout the United States. In addition to carrying hundreds of television and video signals at the same time, these systems are also capable of providing data services, such as internet access.

Data transfer rates on a cable system can exceed the data transfer rate of plain old telephone systems by an order of magnitude or more. The increased bandwidth of a cable communication system means that it is better than the plain old telephone system (POTS) for accessing the internet, including the world wide web, and for transferring the relatively large files associated with the graphics images used on more and more web sites. The POTS network is presently incapable of sustained data transfer rates higher than say 56 kilo bits per second and, only on circuits that have relatively low noise levels.

Despite the larger bandwidth provided by a cable system, it also has physical limitations on the amount of data that it can transfer at any one time. Even when a cable system is not loaded, the media and equipment that comprises the internet itself (fiber, coax, microwave, copper wires) including the various routers, switches, computers and other data transfer devices, all have finite capacities. When the data transfer limits of a media or a switch is reached, further increases in data transfer rates are not possible. When the data transfer rate of a cable or other data network is at it's physical limit, data must either be discarded and lost, or queued up for later delivery. Either way, data transfer slows.

As cable and other data transfer systems grow more popular, it is expected that different classes of service will be offered to subscribers. Some customers of data transfer systems (cable or telephony) might be willing to pay more money for increased capacity. At present, the service class provided to a data network service subscriber is determined by parameters that are programmed into network equipment by the network operator. The DOCSIS standard for cable data systems, specifies that different service classes can be provided to accommodate higher data transfer rates to certain customers. Changing a service class is presently a cumbersome and time-consuming process. A method and apparatus by which a service subscriber could upgrade or downgrade the service class provided to the subscriber by the service provider, would enable the service provider to be more responsive to the subscriber's needs, and at the subscriber's option provide faster or slower service (more or less expensive respectively) while simultaneously providing increased revenues for the available bandwidth of the system. Subscribers who want or need increased bandwidth, might be able to obtain the increased data transfer rate, at a premium price, virtually upon demand.

### SUMMARY OF THE INVENTION

DOCSIS-compliant (“Data-Over-Cable Service Interface Specification Radio Frequency Interface Specification”) cable data systems provide for multiple classes or levels of service to the system subscriber. A subscriber that is granted a relatively high-priority data transfer rate (higher service class) will have its data carried across the system in advance of, or sooner than, other subscribers having lower priority service levels. In a data transfer network, such as cable data system, higher-priority service levels can be provided at premium prices generating increased revenue from customers willing to pay for better service.

The invention is a method and apparatus by which a data service subscriber is enabled to obtain at his own discretion, higher (or lower) service class by accessing a service level computer that effectively controls service class grants. In a DOCSIS compliant cable data system, commands that specify a class of service can be entered to the cable modem termination system (“CMTS”) of the cable system. The CMTS grants service levels on a customer-by-customer basis, depending upon the service class that the various customers have paid for as reflected in customer databases in which various customer data is stored.

A processor is provided that provides a mechanism by which a cable data system subscriber can request service level changes. The processor receives requests for service level changes from the subscriber. It validates the requestor's cable privileges or service level class and instructs the CMTS to upgrade or downgrade the customer's service class. If the customer requests increased or decreased bandwidth (a higher service class at an increased price or a lower service class at a reduced priced) the service level processor initiates increased or decreased service charges to the customer as appropriate. By way of the method and apparatus taught herein, a customer can order faster or slower internet service on an as-needed basis without involving personnel of the cable service provider.

### BRIEF DESCRIPTION OF THE DRAWINGS

FIG. 1 shows a simplified block diagram of a cable communications system, including a block diagram representation of the cable modems resident in subscriber premises.

FIG. 2 shows a simplified block diagram of a service level/billing processor used to automatically grant service level changes in a cable data system.

### DETAILED DESCRIPTION OF THE PREFERRED EMBODIMENT

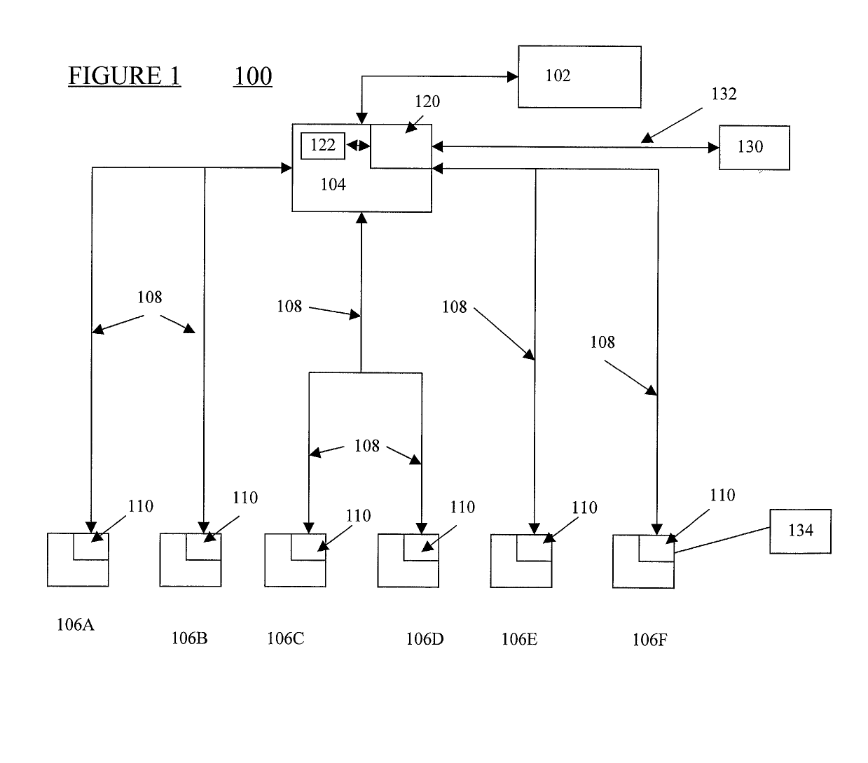

FIG. 1 shows a simplified block diagram of a cable communications system 100. Programming information from a variety of sources originates at some transmission facility 102, the details of which are not germane to this disclosure.

Programming information is relayed to the head end 104 of the cable system 100 where the information is modulated onto predetermined radio frequencies (RF) commonly known as “channels.” The RF signals are frequency multiplexed together (combined) for distribution and transmission to cable system subscribers 106A-106F via a network of discrete transmission lines 108 that couple the subscribers 106A-106F to the head end 104 and its equipment. A DOCSIS-compliant cable data system includes a cable modem termination system or CMTS 120, whose features are defined in the Data Over Cable Service Interface Specification (Radio Frequency Interface Specification) SP-RFIv1.1-I01-991105.

This head-end termination equipment for Cable Data service (known as a Cable Modem Termination System or CMTS) must provide a means for converting the signals from the Internet into the cable TV-like format specified by the DOCSIS specification for downstream traffic, and it must also provide a means for converting the signals from the cable into Internet signals for upstream traffic.

The Internet signals connect to the CMTS at the network side interface (also known as the CMTS-NSI). The cable signals connect to the CMTS at the cable side interface (or radio frequency interface—also known as the CMTS-RFI). In addition to the CMTS-NSI and the CMTS-RFI, the DOCSIS specification also defines two other interfaces for the CMTS: a Data Over Cable System Operations Support System Interface (also known as the DOCS-OSSI) and a Baseline Privacy Interface (also known as the BPI).

In reality, the basic functions in the CMTS include: 1) control of the utilization of bandwidth on the cable, 2) control of the operation of all of the cable modems connected to the cable, 3) conversion of signals between the network side interface (CMTS-NSI) and the cable side interface (CMTS-RFI), 4) de-multiplexing of high-bandwidth signals from the network side interface into multiple low-bandwidth channels on the cable side interface, and 5) multiplexing of several low-bandwidth channels from the cable side interface into high-bandwidth signals on the network side interface. These functions can be contained inside of boxes with varying degrees of complexity.

In addition to the aforementioned downstream source programming information signals, upstream communications are also realized on a cable system 100 for a variety of purposes. Upstream communications, i.e. signals from the subscribers 106A-106F are carried toward the head end 104 in a predetermined frequency band or spectrum below the lowest frequency of the downstream channels. So-called pay per view systems, which allow subscribers to order certain programming, is enabled by way of the upstream channels that allow communications to be made to the head end from the subscribers. Upstream communications also allow a cable data system to be used to carry bi-directional data to and from the subscribers as a data network. The increased bandwidth of a cable system makes it an inherently better network on which to carry large volumes of data than ordinary telephone lines.

In order to send and receive data between the subscribers 106A-106F, each of the subscribers require an industry-standard-compliant cable modem device 110 that is capable of sending and receiving Ethernet-format messages. Cable data modems are specified by an industry standard to have programmed into them, a data identifier that uniquely identifies each modem. By virtue of this unique identifier, the Ethernet-format messages that the cable modems generate for transmission, enable the Ethernet equipment at the head end 104 to precisely identify the source (or origin) of upstream data messages originating from the subscribers 106A-106F. By correlating the unique modem identifier with the customer and the service class the customer is paying for, when the cable system reaches or approaches its capacity limit, the CMTS decides which data packets to send on and which data packets to discard, based at least in part on the class of service to be provided to the packets. By knowing the source of each data packet and the class of service that is provided to the customer from which a data packet originated (or to which a data packet is addressed) the CMTS 120 controls the transmission priority afforded to each customer's packet by service level records stored in a data base 122 within the head end 104 and accessible to the CMTS 120. Valid cable system customers (as indicated by data base 122 records) who want or need high-speed data service, and who pay for increased bandwidth, can have their data packets treated preferentially. High-priority data service means that few packets are lost or delayed with the result being faster network response times for the customer who is provided high-priority service.

As a practical matter, high-priority data service is usually provided at a premium price to the subscriber. The higher-priced service class also means increased revenue to the cable service provider.

While most cable data service subscribers do not need and do not wish to pay for increased bandwidth, there might be periods when a paying cable service subscriber wants or needs increased data transfer rates. For example, when web page download times become annoying slowly during certain hours of the day, an increased data transfer rate that is available on a cable data system might significantly shorten web page down load times. A cable data system subscriber who needs and is willing to pay for additional bandwidth could benefit from a method and apparatus by which increased data rates could be requested on demand and in real time.

During periods when a cable data customer wants or needs higher-speed data transfer, the subscriber who wishes to increase his or her service level priority can do so via customer-originated requests to a service level/billing processor 130. The DOCSIS specification describes a protocol and technique for moving such requests between the CM (110) and the CMTS (104), but it does not adequately describe protocols between the customer and CMTS. In the absence of such protocols, the invention described herein becomes an important advance for the cable data system technology because it enables customers to control changes. The service level/billing processor 130 has access to, and is accessed by subscribers, via a data link 132 between the CMTS 120 and the service level/billing processor 130.

In the preferred embodiment of the invention, the service level/billing processor is a world wide web (“web”) server, with its own universal resource locator (“URL”) and which is accessible via the world wide web. The subscribers 106A-F can “log” onto the service level/billing processor using the internet access privileges provided to them via the cable data network 100. Once logged into this web server, a subscriber can submit a request for additional bandwidth (i.e. a higher class of data service) by supplying appropriate information to the service level/billing processor 130. Typical information that might be required would typically include subscriber account information, including a password to verify the identity of the customer requesting enhanced service.

Upon receipt of a customer request for an enhanced service level classification, the service level/billing processor 130 accesses a data base of service level agreements that document the validity of the customer's status and the class of service previously subscribed to. Billing and payment information might also be examined prior to a decision to grant or deny the customer's request for enhanced service.

An increased class of service is effectuated by commands forwarded from the service level/billing processor 130 to the CMTS 120 via the data link 132. Upon instruction of the processor 130, the CMTS 120 can update the class of service records for the upgraded customer that reside in the CMTS data base 122 so as to indicate the new service level to be provided to the customer.

While the preferred embodiment of the invention contemplates that the service level billing processor 130 is a web server, and therefore accessible to the subscriber as any other web page, alternate embodiments of the invention contemplate the processor 130 is accessible as a dial-up computer. Still other embodiments contemplate the processor be accessible via e-mail or responsive to DTMF tones or voice commands in instances where a cable service provider prefers alternate forms of access to the processor 130.

In the preferred embodiment, upgrading (or downgrading) cable data service classes is performed by a subscriber using its own personal computer 134. A request to upgrade (or downgrade) data service class is made to the cable head end 104 and the CMTS 120 by the PC 134 logging into what appears to be an internet web page. The user interface provided by the processor 130 is a design choice as is the data that might be required to validate a customer as well as the data that must be sent to the CMTS to provide enhanced data rates. Once a request for increased service is received and implemented, increased billing rates for the enhanced service can be passed along to the customer.

While the preferred embodiment contemplates that the service level/billing processor 130 is a web server, which might be co-located with the CMTS 120 at the head end 104 of the network 100, alternate embodiments would contemplate that the processor 130 actually be part of the CMTS 120, or its function be provided by the CMTS 120 and its processing capability. Still other embodiments contemplate that the processor be physically provided by a card or other combination of circuitry coupled into the backplane that is typically supporting the CMTS 120 in a card cage (not shown).

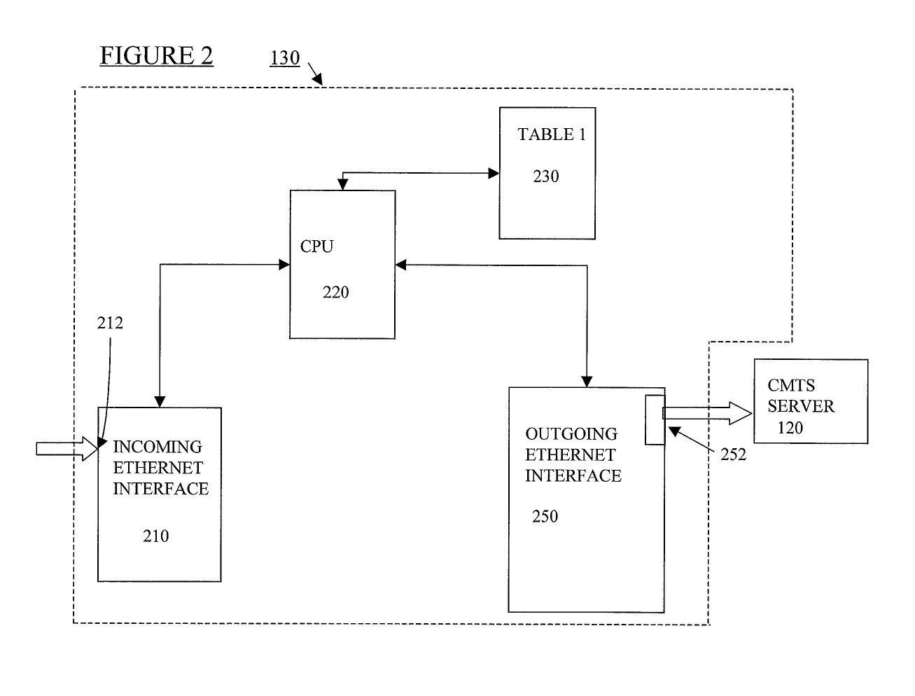

FIG. 2 shows a simplified block diagram of an exemplary service level/billing processor 130.

An incoming physical interface 210 (such as an Ethernet interface) receives messages from subscribers 106A-F. The incoming messages can arrive at the processor 130 via the cable data system 100 itself, but might also arrive by other internet access providers such as AOL for example.

Received requests for new service classes are forwarded to a processor 220 having access to cable subscriber customers and service level agreements in a data base 230. Customer identity can be established by referencing data base records 230 of the cable modem identifiers programmed into DOCSIS-compliant cable modems. Alternate methods of verifying a customer could include passwords and/or account numbers. One customer validity is and a new service level is granted, service class records can be updated in the database 230 so that future data packets are properly treated.

Instruction to the CMTS 120 to increase or decrease bandwidth provided to a particular customer is accomplished by messages from the processor 220 that are forwarded to the CMTS 120 through an outgoing physical port 252 (such as an Ethernet interface) on a physical interface 250.

By use of the foregoing method and apparatus, it is possible for a cable data service provider to immediately grant or deny Internet access service level changes to any valid subscriber. In the preferred embodiment, the CMTS 120 sends and receives signals to a processor by which the CMTS 120 can provide new classes of service to customers without human intervention. By merely tracking the unique point code identifier preprogrammed into every standard-compliant cable modem device a cable service provider can provide cable data service based entirely upon records kept at the head end of whether or not the particular cable modem is authorized to have Internet access service.

While the preferred embodiment contemplates use with a cable data system, the method and apparatus disclosed herein would also be applicable to other forms of data service, such as the data service provided by telephone network providers. The network topology provided by a telephone data service provider is not unlike the topology depicted in FIG. 1.

When a data packet leaves a subscriber's computer 134, the data is routed by a switch or switching system in a central office, depicted by reference number 104. Once the data leaves the central office or switching system 104, the class of service provided by network provider might be varied according the access fee being paid by the subscriber. An enhanced service level might be provided at the customer's request by accessing the service level/billing processor 130, which might then instruct the switching equipment to mark the customer's data as being high (or higher) priority data.

What is claimed is:

1. A data network, providing varying data transfer service levels, comprised of:
a) a data transfer network providing data transfer services to subscribers, said network capable of providing varying levels of data transfer service to service subscribers;
b) at least one modem, operatively coupled to said data transfer network;
c) a data transfer service level/billing processor coupled to said data transfer network and accessible to at least one data service subscriber, said controller enabling said at least one service subscriber to change a data transfer service level that is provided by said data transfer network to said subscriber.

2. The data network of claim 1 wherein said data transfer network is comprised of a telephone network.

3. The data network of claim 1 wherein said at least one modem is a cable modem.

4. The data network of claim 1 wherein said data transfer service level/billing processor is comprised of a web server.

5. The data network of claim 1 wherein said data transfer service level/billing processor is comprised of a dial-in computer.

6. A cable data transfer system capable of providing varying levels of data transfer service to service subscribers comprised of:
a) a cable data system head end;
b) a cable network coupling the cable data system head end to cable data service subscribers;
c) a data transfer service level/billing processor coupled to the cable data system head end and accessible to at least cable data service subscribers, enabling said subscribers to change data transfer service levels provided to a subscriber by said data cable data transfer system.

7. The cable data transfer system of claim 6 wherein said head end includes a CMTS.

8. The data network of claim 6 wherein said data transfer service level/billing processor is comprised of a web server.

9. The data network of claim 6 wherein said data transfer service level/billing processor is comprised of a dial-in computer.

10. A cable data transfer system capable of providing varying levels of data transfer service to service subscribers comprised of:
a) a cable data system head end;
b) a computer coupled to said cable data system head end through a modem;
c) a cable network coupling the cable data system head end to cable data modem service subscribers;
d) a pre-determined protocol server, accessible to service subscribers via said cable data system head end, said pre-determined protocol server being operatively coupled to the cable data system head end, enabling cable data service subscribers to change data transfer service levels that are provided to subscribers by said data cable data transfer system.

11. The cable data transfer system of claim 10 wherein said pre-determined protocol server is a hyper text transfer protocol (HTTP) server.

12. The cable data transfer system of claim 10 wherein said pre-determined protocol server is a world-wide web server.

13. A cable modem termination system (CMTS) having at least one port through which messages are received from a controller that is accessible to cable service subscribers, said messages from said controller changing cable data transfer service levels that are provided to cable data service subscribers coupled to said CMTS.

14. The CMTS of claim 13 wherein said at least one port is comprised of an Ethernet-capable data port.

15. The CMTS of claim 13 wherein said messages are comprised of Ethernet packages.

16. The CMTS of claim 13 wherein said controller is a web server.

17. The CMTS of claim 13 wherein said controller is comprised of a CMTS processor.

18. The CMTS of claim 13 wherein said controller is responsive to voice commands.

19. The CMTS of claim 13 wherein said controller is responsive to DTMF tones.

20. The CMTS of claim 13 wherein said controller effectuates data transfer service classification changes.

21. The CMTS of claim 13 wherein said controller is a controller having access to subscriber service level agreement information.

22. The CMTS of claim 13 wherein said controller is a controller that verifies a cable subscriber's service level.
